(19) United States
(12) Patent Application Publication
(10) Pub. No.: US 2004/0046855 A1
(43) Pub. Date: Mar. 11, 2004

(54) Image forming apparatus

(75) Inventor: Manabu Saito, Saitama (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 10/366,322

(22) Filed: Feb. 14, 2003

(30) Foreign Application Priority Data
Sep. 6, 2002 (JP) P2002-261911

(51) Int. Cl. G03G 15/00

(52) U.S. Cl. 347/138; 399/107; 347/139; 347/140

(57) ABSTRACT

A recording medium supplied from any one of paper supply units 18a to 18d is printed by an image forming section 14, and then, the image-formed recording medium is transported via a transport path 32 which is formed along a vertical direction, and thereafter is ejected to an ejection unit 16 which is provided at an upper portion of an image forming apparatus main body 12. While a developing apparatus 60 of a process cartridge 64 owns a developer storage space 70, a latent image writing position “P” of an image carrier 44 optically written by an optical writing apparatus 58 is located lower than at least a portion of this developer storage space 70, and a space defined between the paper supply unit 18a and the optical writing apparatus 58 is made small.

### BACKGROUND OF THE INVENTION

1. Field of the Invention

The present invention is related to an electro-photographic type image forming apparatus.

2. Description of the Related Art

As this sort of image forming apparatus, such an image forming apparatus is known in which while a recording medium is transported along a substantially vertical direction, an image is formed on this transported recording medium, and then, the recording medium on which the image has been formed is ejected to an ejection unit provided on an upper portion of a main body of this image forming apparatus as disclosed in JP-A-10-207160.

The above-described prior art is represented in FIG. 6. In this prior art, a recording medium which has been transported from a paper supply unit 200 by a transport roller 202 is traveled through a transport path 204 which is formed along a substantially vertical direction, and an image is formed on this recording medium by an image forming section 206, and then, this recording medium on which the image has been formed is ejected to an ejection unit 210 which is formed at an upper portion of a main body 208 of the image forming apparatus. The image forming section 206 contains an image carrier 212 constructed of a photosensitive member, a charging apparatus 214 for charging this image carrier 212, an optical writing apparatus 216, a developing apparatus 218, a transferring apparatus 200, a cleaning apparatus 222, and also a fixing apparatus 224. The charging apparatus 214 charges this image carrier 212. The optical writing apparatus 216 forms a latent image on the image carrier 214 charged by this charging apparatus 214. The developing apparatus 218 develops the latent image of the image carrier 214 formed by this optical writing apparatus 216 so as to produce a visible toner image. The transferring apparatus 218 transfers the toner image of the image carrier 214 developed by this developing apparatus 218 onto the recording medium. The cleaning apparatus 222 is constituted by a blade for cleaning developer left on the image carrier 214. The fixing apparatus 224 fixes the toner image which has been transferred onto the recording medium.

The optical writing apparatus 216 is constituted by a scanning type laser exposing apparatus, and is arranged on the side of the developing apparatus 218. In this prior art, when reliability is taken into account, it is preferable to arrange the optical writing apparatus 216 along a horizontal direction. However, since this optical writing apparatus 216 is arranged along an oblique direction, such a device capable of reducing a width of this optical writing apparatus 216 along forward/backward directions (namely, right/left directions as viewed in FIG. 6) can be made.

However, in such a type of image forming apparatus that the recording medium is transported along the substantially vertical direction, dead spaces 226 and 228 are formed at both upper/lower portions of the optical writing apparatus 216 within the ejection unit 210 provided at the upper portion of this image forming apparatus. In other words, since the developing apparatus 218 is arranged at a position lower than a latent image writing position “P” where the latent image is written onto the image carrier 212 by the optical writing apparatus 216, the optical writing apparatus 216 must be arranged above the developing apparatus 218. As a result, the dead space 226 is formed between the ejection unit 210 and the optical writing apparatus 216, and also, the dead space 228 is formed between the optical writing apparatus 216 and the paper supply unit 200.

### SUMMARY OF THE INVENTION

An object of the present invention is to provide an image forming apparatus capable of reducing a dead space, otherwise, by which even when such a dead space is formed, this dead space can be effectively utilized.

To achieve the above-described object, a first feature of the present invention is to provide an image forming apparatus comprising: an image forming apparatus main body in which an ejection unit is provided at an upper portion thereof; a recording medium storage section arranged along a substantially horizontal direction; a transport path for transporting a recording medium supplied from the recording medium storage section along a substantially vertical direction, and for ejecting the transported recording medium to the ejection unit of the image forming apparatus main body; an image carrier; an optical writing section for forming an electrostatic latent image on the image carrier; and developing section for developing the electrostatic latent image formed on the image carrier to produce a visible image; in which the developing section owns a developer storage space for storing thereinto developer; and a latent image writing position of the image carrier written by the optical writing apparatus is located lower than at least a portion of the developer storage space along the vertical direction. As a consequence, since the latent image writing position written by the optical writing apparatus is located at the lower position, the space defined between the optical writing apparatus and the recording medium storage section can be made smaller than that of the conventional image forming apparatus.

Although a laser apparatus and/or an LED (Light Emitting Diode) may be employed as the optical writing apparatus, a scanning type laser exposing apparatus is employed. This scanning type laser exposing apparatus maybe arranged along a substantially horizontal direction, so that the space defined between the optical writing apparatus and the recording medium storage section arranged along the substantially horizontal direction maybe made smaller. As the optical system of the scanning type laser exposing apparatus, there are both an over-field type optical system and an under-field type optical system. In this over-field type optical system, a width of a luminous flux entered into a rotary polygon along a main scanning direction is made wider than a plane width of this rotary polygon. In the under-field type optical system, a width of a luminous flux entered into a rotary polygon along a main scanning direction is made narrower than a plane width of this rotary polygon. In such a case that a plurality of machine sorts of image forming apparatus are wanted to be manufactured in which printing speeds thereof and maximum paper sizes thereof are changed, while image forming apparatus main bodies and the like are commonly utilized, the over-field type optical system is employed when either a high printing speed or a larger maximum paper size is realized, whereas the under-field type optical system is employed when either a low printing speed or a smaller maximum paper size is realized. Generally speaking, since an optical path of an over-field type optical system is long and complex, a larger installation space is required, as compared with that of an under-field type optical system. To the contrary, in such a case that the optical writing apparatus is arranged along the substantially horizontal direction, a lower space of an ejection unit is extended. As a result, if this lower space is made coincident with the storage capacity of the over-field type, then both the over-field type optical system and the under-field type optical system can be properly utilized while the dead space is suppressed to a minimum dead space.

Also, the optical writing apparatus may be preferably arranged on the front surface side of the image forming apparatus main body.

Also, a control board for controlling drives of the respective components of the image forming apparatus, a network interface board used to constitute a network, or a developer storage vessel for storing thereinto developer is arranged in another space defined between the ejection unit and the optical writing apparatus, sot that this space can be effectively utilized.

As explained above, in order that the developer storage space is formed at the position higher than the latent image writing position written by the optical writing apparatus, the developer storage space is subdivided into a first developer storage portion arranged at an upper portion thereof, and a second developer storage portion arranged at a lower portion thereof, and also, a window portion is formed between these first and second developer storage portions. As a result, an optical scanning path from the optical writing apparatus can be constituted by this window portion. Also, when such a construction is made that at least a portion of the optical writing apparatus is arranged to be overlapped with respect to the developer storage space along a direction in parallel to an optical axis of incident light to the image carrier, since the incident light optical axial direction of the image forming apparatus can be made short, the better construction of the image forming apparatus can be realized.

### BRIEF DESCRIPTION OF THE DRAWINGS

FIG. 1 is a sectional view for indicating an image forming apparatus according to a first embodiment mode of the present invention.

FIG. 2 is a sectional view for representing a process cartridge employed in the image forming apparatus according to the first embodiment mode of the present invention.

FIG. 3 is a side view for showing a supply path of developer in the process cartridge employed in the image forming apparatus according to the first embodiment mode of the present invention.

FIG. 4 is a side view for indicating a portion of an image forming apparatus according to a second embodiment mode of the present invention.

FIG. 5 is a sectional view for indicating a portion of an image forming apparatus according to a third embodiment mode of the present invention.

FIG. 6 is a sectional view for showing the conventional image forming apparatus.

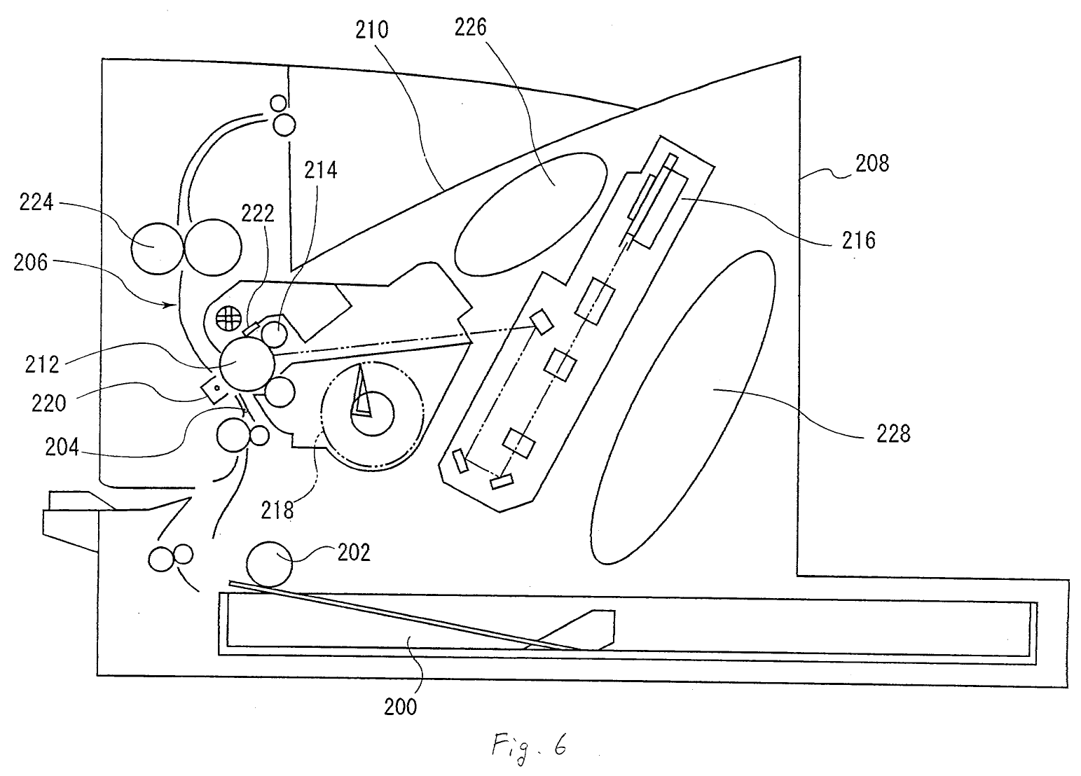

### DETAILED DESCRIPTION OF THE PREFERRED EMBODIMENTS

Referring now to drawings, embodiment modes of the present invention will be described.

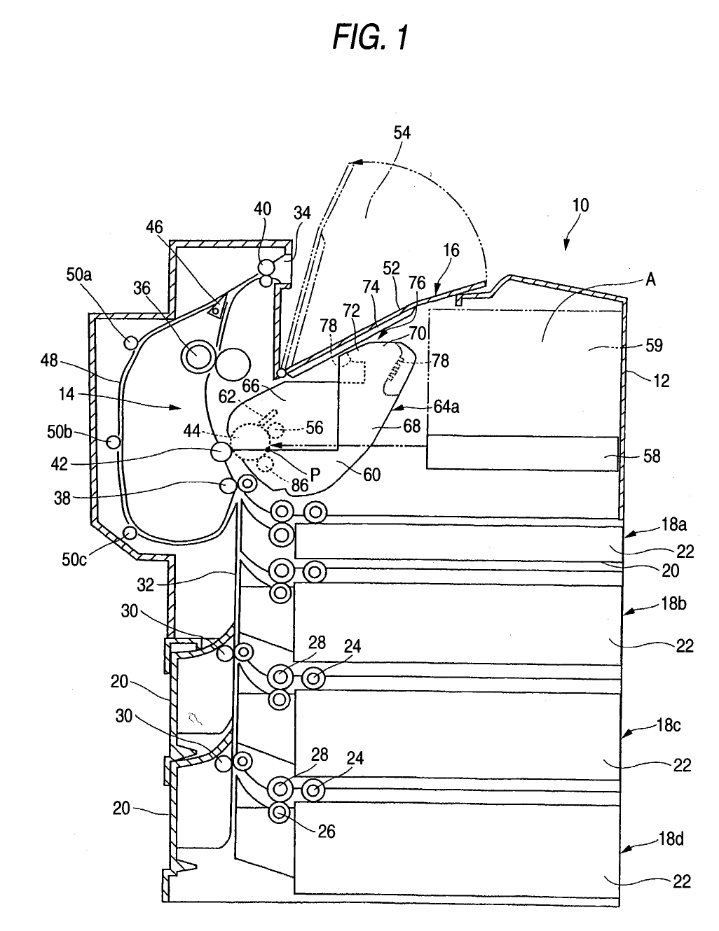

FIG. 1 schematically shows an image forming apparatus 10 according to a first embodiment mode of the present invention. The image forming apparatus 10 contains a main body 12 of the image forming apparatus. An image forming section 14 is mounted on this image forming apparatus main body 12. An ejection unit 16 (will be explained later) is provided at an upper portion of this image forming apparatus main body 12, and also, for instance, two stages of paper supply units 18a and 18b are arranged at a lower portion of this image forming apparatus main body 12. Furthermore, two stages of paper supply units 18c and 18d are arranged below the image forming apparatus main body 12, while these paper supply units 18c and 18d are detachably mounted thereon as an optional paper supply unit.

Each of the paper supply units 18a to 18d owns a paper supply unit main body 20 and a paper supply cassette 22 into which paper is stored. The paper supply cassette 22 is slidably mounted with respect to the paper supply unit main body 20, and is drawn out from this paper supply unit main body 20 along a front plane direction (namely, right direction of FIG. 1). Also, a paper supply roller 24 is arranged at an upper portion near an inner end of the paper supply cassette 22, and both a retard roller 26 and a nudger roller 28 are arranged in front of this paper supply roller 24. Furthermore, feed rollers 30 are provided with the optionally-provided paper supply units 18c and 18d, and these feed rollers 30 may constitute a pair of feed rollers.

A transport path 32 corresponds to a paper path defined from the feed roller 30 of the lowermost paper supply unit 18d up to an ejection port 34. While this transport path 32 is located in the vicinity of a rear surface (namely, left side surface viewed in FIG. 1) of the image forming apparatus main body 12, this transport path 32 owns such a portion which is formed along the substantially vertical direction from the feed roller 30 of the lowermost paper supply-unit 18d up to a fixing apparatus 36 (will be discussed later). Both a transferring apparatus 42 (will be explained later) and an image carrier 44 (will be explained later) are arranged on an upper stream side of the fixing apparatus 36 of this transport path 32. Furthermore, a register roller 38 is arranged on an upper stream side of both the transferring apparatus 42 and the image carrier 44. In addition, an ejection roller 40 is arranged in the vicinity of an ejection port 34 of the transport path 32.

As a result, the recording mediums which are fed out from the paper supply cassettes 22 of the paper supply units 18a to 18d are smoothly separated by the retard roller 26 and the nudger roller 28 to be conducted to the transport path 32, and then, are temporarily stopped by the register roller 38. After proper timing is controlled, a developer image is transferred to the recording medium while the recording medium is penetrated between the transferring apparatus 42 and the image carrier 44 (will be explained later), and this transferred developer image is fixed on the fixing apparatus 36, and then, the recording medium on which the fixed image has been formed is ejected from the ejection port 34 to the ejection unit 16 by the ejection roller 40.

It should be noted that when a double-surface printing mode is carried out, this recording medium is returned to an inversion path 48. In other words, a front path portion of the transport path 30 as to the ejection roller 40 is separated into two paths, a switching craw 46 is provided at this separated path portion, and the inversion path 48 is formed from this separated path portion up to the register roller 38. While transport rollers 50a to 50c are provided in this inversion path 48, in the case of the double-surface printing mode, the switching claw 46 is switched to such a side that the inversion path 48 is opened. Then, the ejection roller 40 is inverted at a time instant when a front edge portion of a recording medium is engaged with the ejection roller 40, so that this recording medium is conducted to the inversion path 48, and then, is penetrated through the register roller 38, the transfer apparatus 42, the image carrier 44, and the fixing apparatus 36 so as to be ejected from the ejection port 34 to the ejection unit 16.

The ejection unit 16 owns an inclination unit 52 which is freely pivotable with respect to the image forming apparatus main body 12. This inclination unit 52 is inclined in such a manner that an ejection port portion is low and is gradually heightened toward a front surface direction (namely, right direction viewed in FIG. 1). This ejection port portion is used as a lower end of the inclination unit 52 and a tip portion which is heightened is used as an upper end thereof. This inclination unit 52 is supported with respect to the image forming apparatus main body 12 in such a manner that this inclination unit 52 is freely pivotable, while the lower end thereof is located at a center. When this inclination unit 52 is rotated toward the upper direction so as to be opened, an open unit 54 is formed, and a process cartridge (will be explained later) 64 can be detachably mounted via this opening unit 54.

The image forming section 14 is made of, for instance, an electro-photographic type image forming unit. This image forming section 14 is arranged by the image carrier 44 constructed of a photosensitive material, a charging apparatus 56, an optical writing apparatus 58, a developing apparatus 60, a transferring apparatus 42, a cleaning apparatus 62, and a fixing apparatus 36. The charging apparatus 56 is constituted by, for example, a charge roller capable of uniformly charging the image carrier 44. The optical writing apparatus 58 writes a latent image in an optical manner on the image carrier 44 charged by the charging apparatus 56. The developing apparatus 60 develops the latent image of the image carrier 44, which has been formed by the optical writing apparatus 58, by way of developer so as to produce a visible image. The transferring apparatus 42 is constituted by, for example, a transfer roller which transfers the developer image by the developing apparatus 60 to paper. The cleaning apparatus 62 is constituted by, for instance, a blade which cleans the developer left on the image carrier 44. The fixing apparatus 36 is arranged by both a pressure-applying roller and a heating roller, by which the developer image which has been transferred onto the paper by the transferring apparatus 42 is fixed on this paper. The optical writing apparatus 58 is constructed of, for example, a scanning type laser exposing apparatus, and is arranged in parallel to the above-described paper supply units 18a to 18d, and is located in the vicinity of a front surface of the image forming apparatus menu body 12. As will be explained later, the optical writing apparatus 58 exposes the image carrier 44 by scanning light beams across the inner space of the developing apparatus 60. This exposing position of the image carrier 44 may constitute a latent image writing position “P”. This exposing position “P” is located lower than an upper portion of a developer storage space (will be explained later) 70 along the vertical direction.

The optical writing apparatus 58 is arranged in a space “A” within the image forming apparatus main body 12, while this space “A” is surrounded by the ejection unit 16, the uppermost paper supply unit 18a, the process cartridge 64, and the front surface portion of the image forming apparatus main body 12. In this first embodiment mode, the optical writing apparatus 58 owns an under-field type optical system in which a width of a luminous flux entered into a rotary polygon along the main scanning direction is made narrower than a plane width of the rotary polygon. Since this optical writing apparatus 58 owns the under-field type optical system, a width of this optical writing apparatus 58 along the vertical direction is made narrower, and the under-field type optical system is arranged at a lower portion of the space “A” for arranging the optical writing apparatus 58. It should also be noted that this space “A” is set under such a condition that another optical writing apparatus 59 (denoted by two dot/dash line in FIG. 1) having an over-field type optical system may be accepted. In this over-field type optical system, a width of a luminous flux entered into a rotary polygon is made wider than a plane width of this rotary polygon. Thus, the above-described optical writing apparatus 58 may be replaced by this optical writing apparatus 59. Since this another optical writing apparatus 59 is mounted and the presently-used drive system is substituted by another drive system, the presently-used image forming apparatus may be changed into either a high-speed type image forming apparatus or such an image forming apparatus having a larger maximum paper size than that of the presently-used image forming apparatus 10, while other components thereof are commonly used.

As explained in this first embodiment mode, when either the optical writing apparatus 58 or the optical writing apparatus 59 is arranged along the substantially horizontal direction, the rotary polygon may be rotated by being maintained along the substantially horizontal direction, so that reliability thereof with respect to the rotation of the rotary polygon may be improved.

It should also be noted that a door is provided on the front surface portion of the image forming apparatus main body 12, and then, since this door is opened/closed, the replacement of the optical writing apparatus 58 may be readily carried out.

The process cartridge 64 is arranged by employing the image carrier 44, the charging apparatus 54, the developing apparatus 58, and the cleaning apparatus 60 in an integral body. This process cartridge 64 is arranged just under the inclination unit 52 of the ejection unit 16, and as previously explained, is detachably mounted via the open portion 54 which is formed when the inclination unit 52 is opened.

This process cartridge 64 is detachably separated into an image carrier unit 66 and a developing apparatus unit 68. In the image carrier unit 66, the image carrier 44, the charging apparatus 54, and the cleaning apparatus 60 are arranged. In the developing apparatus unit 68, the developing apparatus 58 is arranged. The developing apparatus unit 68 owns a developer storage space 70 which stores thereinto, for example, developer. An upper portion of this developer storage unit 70 belongs to such an area which is surrounded by the inclination unit 52, a horizontal plane extended from the lower end of the inclination unit 52, and also, a vertical plane extended from the upper end of this inclination unit 52. Also, an upper wall plane 72 which constitutes the developer storage space 70 is formed in such a manner that this upper wall plane 72 is located in parallel to the inclination unit 52 and along this inclination unit 52. Also, a plurality of ribs 74 are formed on a lower surface of the inclination unit 52 in such a way that these plural ribs 74 are positioned in parallel to each other along the inclination direction of the inclination unit 52. Since these ribs 74 are formed, a flow path 76 is formed between the inclination unit 52 and the process cartridge 64. This flow path 76 is employed so as to penetrate air therethrough, and this flow path 76 may disperse heat produced from the fixing apparatus 36. Furthermore, a grip unit 78 is formed on the upper portion of the developer storage space 70. This grip unit 78 is formed in such a manner that wall surfaces of both sides of the upper portion of the developer storage space 70 are entered into the inside thereof. When the process cartridge 64 is detachably mounted, this process cartridge 64 can be readily detachably mounted by gripping this grip unit 78.

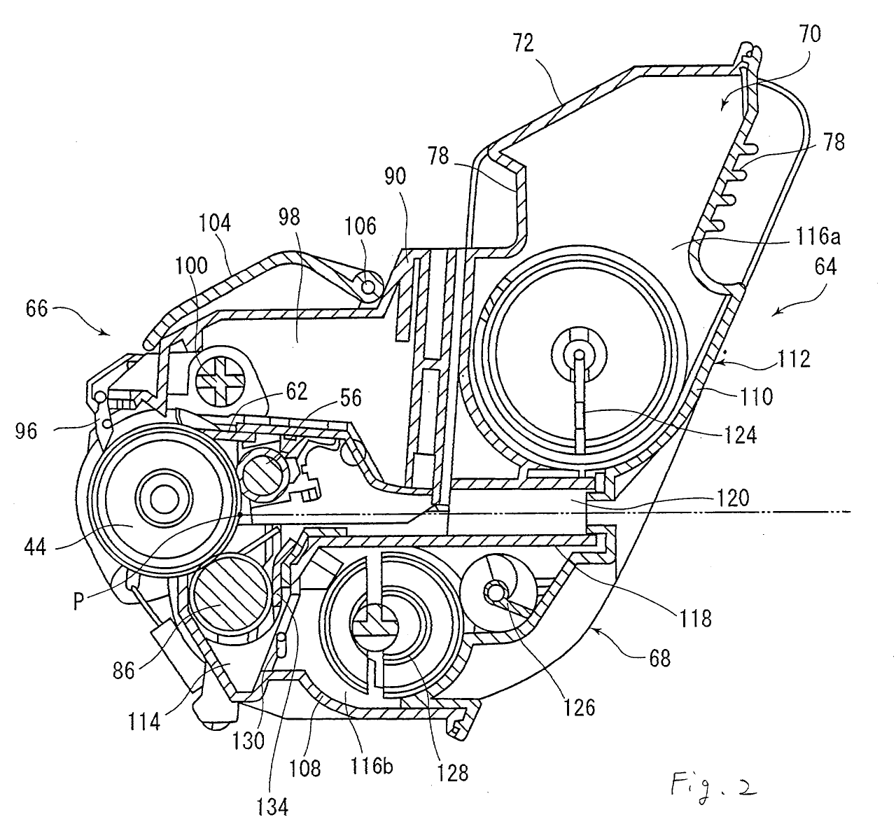

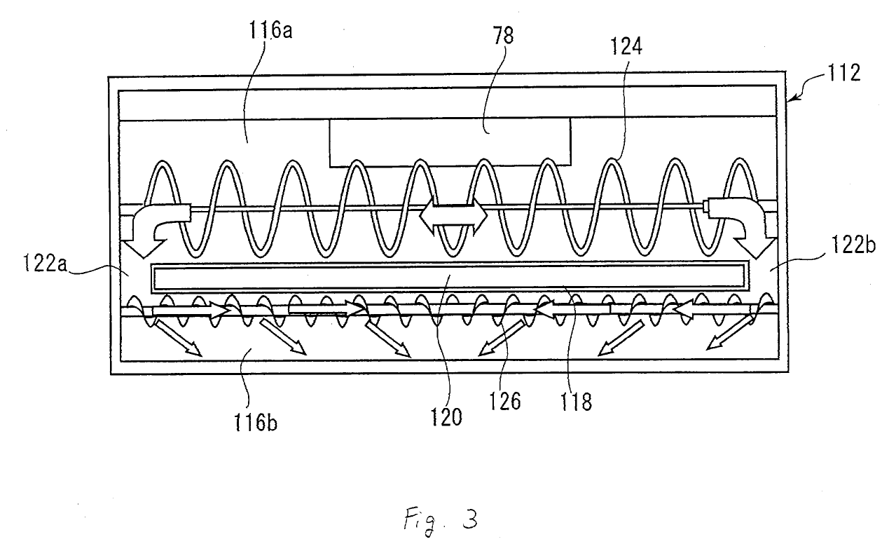

In FIG. 2 and FIG. 3, a detailed construction of the above-described process cartridge 64 is indicated. As explained above, the process cartridge 64 is arranged by the image carrier unit 66 and the developing apparatus unit 68, and this image carrier unit 66 is coupled to the developing apparatus unit 68 via a coupling pin (not shown) in such a manner that this image carrier unit 66 is freely pivotable with respect to the developing apparatus unit 68. Also, both the image carrier unit 66 and the developing apparatus 68 are energized with each other by a spring (not shown), and a developing roller 86 is depressed against the image carrier 44.

The image carrier unit 66 owns a main body 90 of the image carrier unit 66, and both the image carrier 44 and the charging apparatus 56 are supported by this image carrier unit main body 90 in such a manner that both the image carrier 44 and the charging apparatus 56 are rotatably supported. Both a bearing 94a and another bearing 94b for the charging apparatus 56 own another function of a power supply portion. Also, for example, two fingers 96 are supported by the image carrier unit main body 90 in such a manner that these fingers 96 are freely pivotable. Since tip portions of these fingers 96 are depressed on the surface of the image carrier 44, a recording medium which will wrap the image carrier 44 is stripped by these tip portions. Also, a developer collecting space 98 is formed above the cleaning apparatus (cleaning blade) 62 within the image carrier unit main body 90, and thus, developer which has been scratched/dropped by the cleaning apparatus 62 is collected into this developer collecting space 98. A paddle 100 is rotatably provided in this developer collecting space 98. This paddle 100 is supported by the image carrier unit main body 98, and transports the developer which has been collected by being rotated to an inner side of the developer collecting space 98. Also, a shutter 104 is provided at the upper portion of the image carrier unit main body 90 in such a manner that this shutter 104 can be freely opened/closed. This shutter 104 is supported via a shaft 106 for the shutter 104 with respect to the image carrier unit main body 90 in a freely movable manner. This shutter 104 closes an opening portion of the image carrier 44 before the process cartridge 64 is mounted, and is opened in order that the image carrier 44 is come out to the front in the case that the process cartridge 64 is mounted.

The developing apparatus unit 68 contains a main body 112 of the developing apparatus unit 68 which is constituted by jointing a front housing 108 to a rear housing 110. An inner space of this developing apparatus unit main body 112 is segmented into the above-described developer collecting space 70 and a developing unit 114 in which the developing roller 86 is arranged. The developer collecting space 70 is separated into a first developer storage portion 116a and a second developer storage portion 116b via a partition wall 118, while a horizontal line extended from the latent image writing position “P” is defined as a boundary. This horizontal line corresponds to a scanning optical path originated from the optical writing apparatus 58. The first developer collecting portion 116a is located at an upper portion of the developer collecting space 70, whereas the second developer storage portion 116b is located at a lower portion thereof.

As indicated in FIG. 3, the partition wall 118 forms a window portion 120 having, for example, a rectangular shape, which is located in parallel to an incident optical axis from the optical writing apparatus 58 to the image carrier 44. Also, this partition wall 118 constitutes developer paths 122a and 122b in connection with the developing apparatus unit main body 112 on both sides of this window portion 120. Both the developer paths 122a and 122b cause the first developer storage portion 116a to be communicated with the second developer storage portion 116b. In the first developer storage portion 116a, a first stirring/transporting member 124 is rotatably arranged. This first stirring/transporting member 124 is constituted by such a wire member which is formed in a helical shape along different winding directions to each other. The first stirring/transporting member 124 supplies the developer stored in the first developer storage port 116a to the developer paths 122a and 122b. A second stirring/transporting member 126 is rotatably arranged at a lower position of the first stirring/transporting member 124 within the second developer storage unit 116b. This second stirring/transporting member 126 is constituted by a screw shaft formed along different directions from edge portions thereof (viewed along axial direction) toward a center portion thereof. Since the developer is uniformly dispersed by the second stirring/transporting member 124, the developer supplied from the developer paths 122a and 122b formed on the both sides may be transported along the center direction. As a consequence, as indicated by an arrow of FIG. 3, the developer which has been stored in the first developer storage unit 116a is transported to the both sides of the first stirring/transporting member 124 by this first stirring/transporting member 124, and then, is dropped via the developer paths 122a and 122b to the second developer storage unit 116b, and thereafter is uniformly dispersed by rotating the second stirring/transporting member 124, so that the dispersed developer is transported to the side of the developing roller 86.

Furthermore, both a third stirring/transporting member 128 and a fourth stirring/transporting member 130 are arranged in the second developer storage portion 116b. The third stirring/transporting member 128 transports the developer transported by the second stirring/transporting member 126 to the fourth stirring/transporting member 130. This fourth stirring/transporting member 130 is arranged at an output port of the second developing member storage portion 116b. The fourth stirring/transporting member 130 transports the developer which has been transported by the third stirring/transporting member 128 to the developing roller 86, and also, mixes this new developer with the deteriorated developer which has been scratched/dripped from the developing roller 86.

A layer thickness restricting member 134 made of, for instance, a resin is made in contact with the developing roller 86. A thickness of a developer layer adhered on the surface of the developing roller 86 is restricted by this layer thickness restricting member 134.

As previously explained, the latent image writing position “P” of the image carrier 44 is located at the position lower than the first developer storage portion 116a. Also, since the optical writing apparatus 58 is substantially horizontally arranged, the upper portion of the optical writing apparatus 58 is arranged in such a manner that this upper portion is overlapped with respect to the first developer storage portion 116a in the direction parallel to the optical axis of the light entered into the image carrier 44.

Next, operations of the above-described image forming apparatus according to this first embodiment mode will now be explained.

While the image carrier 44 is uniformly charged by the charging apparatus 56, light emitted from the optical writing apparatus 58 is irradiated onto this charged image carrier 44 in response to an image signal, and then, a latent image is formed at the latent image forming position “P” thereof. The light emitted from the optical writing apparatus 58 passes through the process cartridge 64 via the window portion 108 of the process cartridge 64. The latent image which has been formed on the image carrier 44 by this optical writing apparatus 58 is developed by the developer of the developing apparatus 60 so as to produce a visible image.

While the developer has been stored in both the first developer storage portion 116a and the second developer storage portion 116b, the developer stored in the first developer storage portion 116a is transported to both sides by rotating the first stirring/transporting member 124, and then both the developer located on the both sides is transported via the two developer paths 122a and 122b to the second developer storage unit 116b. Furthermore, the developer of the second developer storage portion 116b is uniformly dispersed by rotating the second stirring/transporting member 126, and then, the uniformly dispersed developer is transported to the developing unit 114 by the third stirring/transporting member 128 and the fourth stirring/transporting member 130. In this developing unit 114, the transported developer is adhered onto the developing roller 86, the layer thickness of the adhered developer is restricted by the layer thickness restricting member 134, the thickness restricted developer is transported up to a developing position located opposite to the image carrier 44, and then, an image made of the developer is formed in correspondence with the latent image of the image carrier 44.

On the other hand, one of the paper supply units 18a to 18d is selected in response to a size signal and the like, recording mediums stored in one of these paper supply cassettes 22 are fed out by the feeding roller 24, and these recording mediums are smoothly separated by the retard roller 26 and the nudger roller 28 so as to conduct a recording medium to the transport path 32. Then, this conducted recording medium is temporarily stopped by the register roller 38, and thereafter, this recording medium is conducted between the transferring apparatus 42 and the image carrier 44 at proper timing.

When the recording medium is conducted between the transferring apparatus 42 and the image carrier 44 in this manner, the developer on the image carrier 44 is transferred to the recording medium by the transferring apparatus 42. This recording medium to which the developer has been transferred is penetrated through the fixing apparatus 36, and then is ejected from the ejection port 34 to the ejection unit 16.

The recording medium is penetrated through the transport path 32, and then is ejected to the ejection unit 16, and thus a so-called “C-path” is constituted, while this transport path 32 is formed along the substantially vertical direction from the paper supply units 18a to 18d arranged along the horizontal direction. In this embodiment mode, since the process cartridge 64 is stored within the C-path, the layout of this image forming apparatus can be made compact. However, if the developer storage space connected to the developing unit 114 is arranged lower than the latent image writing position “P” in the normal design manner, such a dead space is produced between the paper supply unit 18a and the optical writing apparatus 58. More specifically, in the case that a storage capacity of the developer is increased, since the space located lower than the latent image writing position “P” must be increased, a larger dead space is produced.

However, in this first embodiment mode, the window portion 120 which constitutes the scanning optical path from the optical writing apparatus 58 is formed in the process cartridge 64, and also, the developer paths 122a and 123b are formed on both sides of this window portion 120, so that the first developer storage portion 116a can be arranged above the scanning optical path. As a result, the position of the optical writing apparatus 58 can be lowered, and also, the space defined between the paper supply unit 18a and the optical writing apparatus 58 can be made small. In this case, although the space is produced between the ejection unit 16 and the optical writing apparatus 58, another optical writing apparatus 58 may be arranged in this space, so that a plurality of machine sorts of image forming apparatus may be manufactured while the main bodies of the image forming apparatus and the like are commonly used.

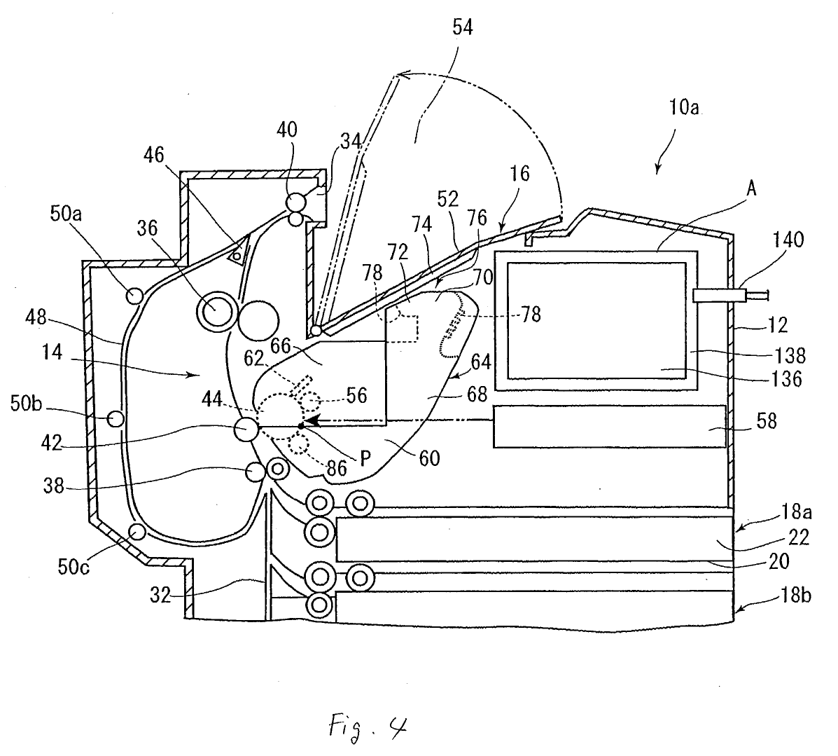

FIG. 4 indicates an image forming apparatus according to a second embodiment mode of the present invention. In this second embodiment mode, both a control board 136 and a network interface board 138 are stored in a space “A”. A control circuit for controlling a drive system of the power supply units 18a to 18d, and also a drive system of the image forming section 14 is mounted on this control board 136. A circuit such as a router is mounted on the network interface board 138, and this circuit is used to connect the image forming apparatus via this network interface board 138 to a LAN (Local Area Network) and the Internet. This network interface board 138 owns a connector 140, and this connector 140 is arranged at a front surface portion of the image forming apparatus main body 12. As a consequence, since both the control board 136 and the network interface board 138 are arranged on the front surface of the image forming apparatus main body 12, users may easily access the boards, so that the maintenance characteristic thereof may be improved. Moreover, since the connector 140 for the network cable is arranged on the front surface of the image forming apparatus, the installation characteristic may be improved, and also the network cable may be readily connected.

It should be understood that both the control board 136 and the network interface board 138 are arranged in the space A in this second embodiment mode. Alternatively, any one of the control board 136 and the network interface board 138 may be arranged in the space A. Also, both the control board 136 and the network interface board 138 may be collectively mounted on a single board.

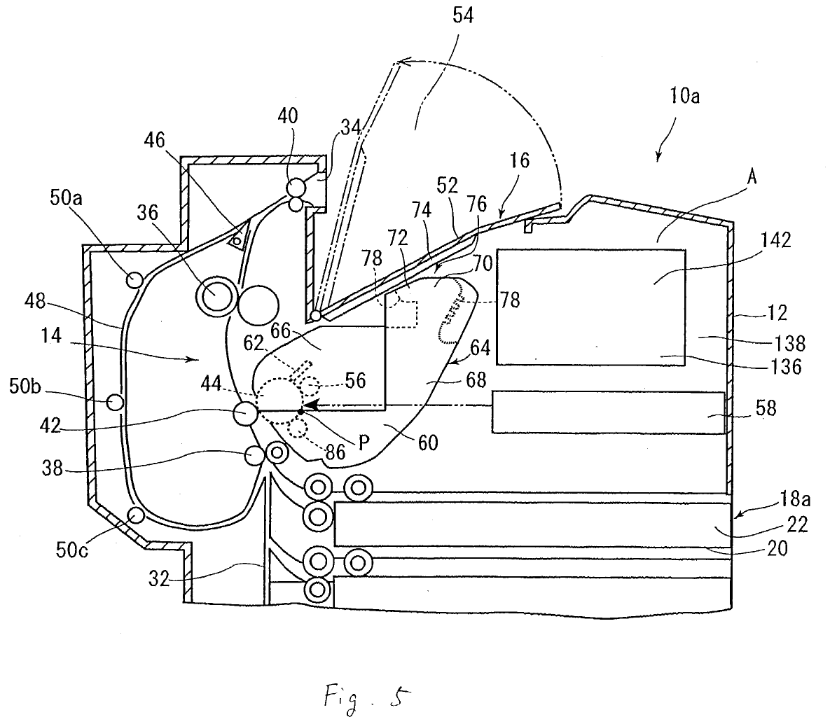

FIG. 5 indicates an image forming apparatus according to a third embodiment mode of the present invention. In this third embodiment mode, a developer storage vessel 142 is arranged in a space “A”. While developer is stored in this developer storage vessel 142, the developer storage vessel 142 is connected to the above-described first developer storage unit 116a, so that the developer can be supplied to the first developer storage portion 116a. In other words, this developer storage vessel 142 constitutes a third developer storage portion, and this developer storage vessel 142 is arranged in the case that a storage capacity of the developer is wanted to be increased. As previously described, since the space “A” is utilized as the developer storage portion, the storage capacity of the developer may be simply increased without changing other structural elements.

It should also be understood that the developer storage vessel 142 is constructed as a separate member with respect to the process cartridge 64 in this third embodiment mode. Alternatively, as another embodiment mode, the developer storage vessel 42 may be constituted by employing the process cartridge 64 in an integral form. Also, not only the developer storage vessel 142, but also the above-described control board and network interface board may be jointly stored in the space “A”.

As previously described, in accordance with the present invention, since the latent image writing position is set to be lower than at least a portion of the developer storage space, the space defined between the optical writing apparatus and the paper supply unit can be made narrow, and also the production of the dead space can be suppressed. Also, the control board, the interface board, the developer storage vessel, and the like are arranged between the ejection unit and the optical writing apparatus, so that the space can be effectively utilized.

What is claimd is:

1. An image forming apparatus comprising:
an image forming apparatus main body in which an ejection unit is provided at an upper portion thereof;
a recording medium storage section arranged along a substantially horizontal direction;
a transport path for transporting a recording medium supplied from the recording medium storage section along a substantially vertical direction, and for ejecting the transported recording medium to the ejection unit of the image forming apparatus main body;
an image carrier;
an optical writing section for forming an electrostatic latent image on the image carrier; and
a developing section for developing the electrostatic latent image formed on the image carrier to produce a visible image, wherein
the developing section owns a developer storage space for storing thereinto developer; and
a latent image writing position of the image carrier written by the optical writing apparatus is located lower than at least a portion of the developer storage space along the vertical direction.

2. The image forming apparatus according to claim 1, wherein
the optical writing apparatus is a scanning type laser exposing apparatus, and
the scanning type laser exposing apparatus is arranged along the substantially horizontal direction.

3. The image forming apparatus according to claim 1, wherein
the optical writing apparatus is arranged on the side of a front surface of the image forming apparatus main body within the image forming apparatus main body.

4. The image forming apparatus according to claim 1, wherein
a control board is arranged between the ejection unit of the image forming apparatus main body and the optical writing apparatus.

5. The image forming apparatus according to claim 1, wherein
an interface board is arranged between the ejection unit of the image forming apparatus main body and the optical writing apparatus.

6. The image forming apparatus according to claim 1, wherein
a developer storage vessel for storing thereinto the developer is arranged between the ejection unit of the image forming apparatus main body and the optical writing apparatus.

7. An image forming apparatus according to claim 2, wherein
the developer storage space owns a window portion which constitutes an optical scanning path defined from the optical writing section to the image carrier.

8. The image forming apparatus according to claim 7, wherein
the developer storage space owns a first developer storage portion arranged at an upper portion thereof, and a second developer storage portion arranged at a lower portion thereof, while the window portion is set to a boundary.

9. The image forming apparatus according to claim 1, wherein
at least a portion of the optical writing apparatus is arranged to be overlapped with respect to the developer storage space along a direction in parallel to an optical axis of incident light to the image carrier.
